(19) United States
(12) Patent Application Publication
(10) Pub. No.: US 2026/0027842 A1
(43) Pub. Date: Jan. 29, 2026

(54) PRINTING DEVICE

(71) Applicant: SEIKO EPSON CORPORATION, Tokyo (JP)

(72) Inventors: Nobuhiko HAMADA, SHIOJIRI-SHI (JP); Toshiaki ISHIKAWA, MATSUMOTO-SHI (JP)

(21) Appl. No.: 19/277,663

(22) Filed: Jul. 23, 2025

(30) Foreign Application Priority Data
Jul. 26, 2024 (JP) 2024-120946

(51) Int. Cl. B41J 11/00; B41J 11/02; B41J 15/04; B41J 15/16; B41J 29/377; B41M 7/00

(52) U.S. Cl. CPC B41J 11/00242; B41J 11/007; B41J 15/046; B41J 15/16; B41J 29/377; B41M 7/009; B41J 11/02

(57) ABSTRACT

A printing apparatus includes a printing section 6 for printing on a medium M by applying liquid, a medium support section 7 for supporting the medium applied with the liquid, a heating section 8 for heating the medium supported by the medium support section, a temperature detection section 9 for detecting the temperature of the medium or the medium support section, and a control section 12 for performing feedback control of the heating section so that the detected temperature detected by the temperature detection section becomes a set temperature, wherein the control section sets the set temperature after printing is finished to be lower than the set temperature during printing.

The present application is based on, and claims priority from JP Application Serial Number 2024-120946, filed Jul. 26, 2024, the disclosure of which is hereby incorporated by reference herein in its entirety.

### BACKGROUND

### 1. Technical Field

The present disclosure relates to a printing device.

### 2. Related Art

In the related art, as shown in JP-A-2018-12323, a printing device is disclosed that includes a liquid applying section which applies a liquid and a drying device that dries a transported member that was applied with liquid and transported. In the printing device described in JP-A-2018-12323, the heating means is turned off when the temperature of the support member supporting the transported member becomes equal to or higher than a predetermined temperature that was set in advance.

However, in the printing device described in JP-A-2018 12323, the temperature of the support member lowers excessively by the heating means being turned off. Therefore, there is a possibility that the user has to wait until the temperature of the support member rises when printing is performed again.

### SUMMARY

A printing device includes a printing section that performs printing on a medium by applying a liquid; a medium support section that supports the medium to which the liquid is applied; a heating section that heats the medium supported by the medium support section; a temperature detection section that detects a temperature of the medium or of the medium support section; and a control section configured to perform feedback control on the heating section such that a detected temperature detected by the temperature detection section becomes a set temperature, wherein the control section sets the set temperature after printing is finished to be lower than the set temperature during printing.

### BRIEF DESCRIPTION OF THE DRAWINGS

FIG. 1 is a schematic cross-sectional view showing configuration of a printing device.

FIG. 2 is a block diagram illustrating configuration of a printing device.

FIG. 3 is a schematic view showing configuration of main sections of the printing device as viewed from above in FIG. 1.

FIG. 4 is a flowchart showing temperature control of the printing device.

### DESCRIPTION OF EMBODIMENTS

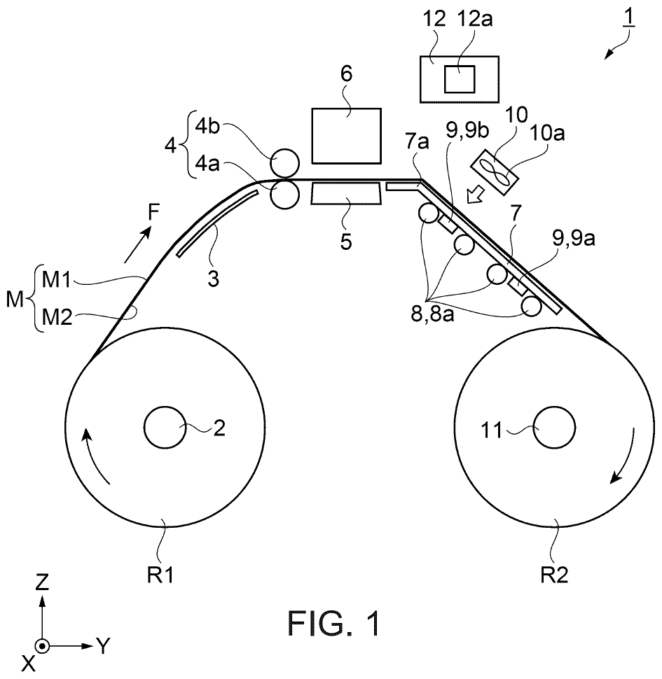

Hereinafter, a printing device 1 of the present embodiment will be described with reference to the drawings. The printing device 1 illustrated in FIG. 1 is, for example, an ink jet printer that prints an image such as a character or a photograph on a medium M by applying ink, which is an example of “liquid”, onto the medium M being transported.

In the drawings described below, the scale of the members differ from the actual scale in order to make the members have a recognizable size. In the drawings, the same components are denoted by the same reference numerals, and redundant description thereof will be omitted. Further, in each drawing, at least one or more of an X axis, a Y axis, and a Z axis are illustrated as coordinate axes orthogonal to each other as necessary. Arrows are attached to the X axis, the Y axis, and the Z axis, respectively. In each of the X axis, the Y axis, and the Z axis, the direction of the arrow is the positive direction, and the direction opposite to the direction of the arrow is the negative direction.

The Y axis is an axis parallel to the installation surface of the printing device 1 and corresponds to the depth direction of the printing device 1. The positive direction of the Y axis is a direction from the rear surface to the front surface of the printing device 1. The X axis is an axis parallel to the installation surface of the printing device 1, and corresponds to the width direction of the printing device 1 and the width direction of the medium M. The positive direction of the X axis is a direction from the right to the left of the printing device 1 when the front surface of the printing device 1 is viewed from the front. The Z axis is an axis perpendicular to the installation surface of the printing device 1 and corresponds to the height direction of the printing device 1. The positive direction of the Z axis is a direction from the lower side to the upper side of the printing device 1.

In the printing device 1, a positive direction of the X axis is referred to as a left direction or simply left, and a negative direction is referred to as a right direction or simply right. The positive direction of the Y axis is referred to as a forward direction or simply forward, and the negative direction is referred to as a rearward direction or simply rearward. The positive direction of the Z axis is referred to as an upward direction or simply up, and the negative direction is referred to as a downward direction or simply down. Note that in the printing device 1, the direction in which the medium M is transported is also referred to as downstream, and the direction opposite thereto is also referred to as upstream.

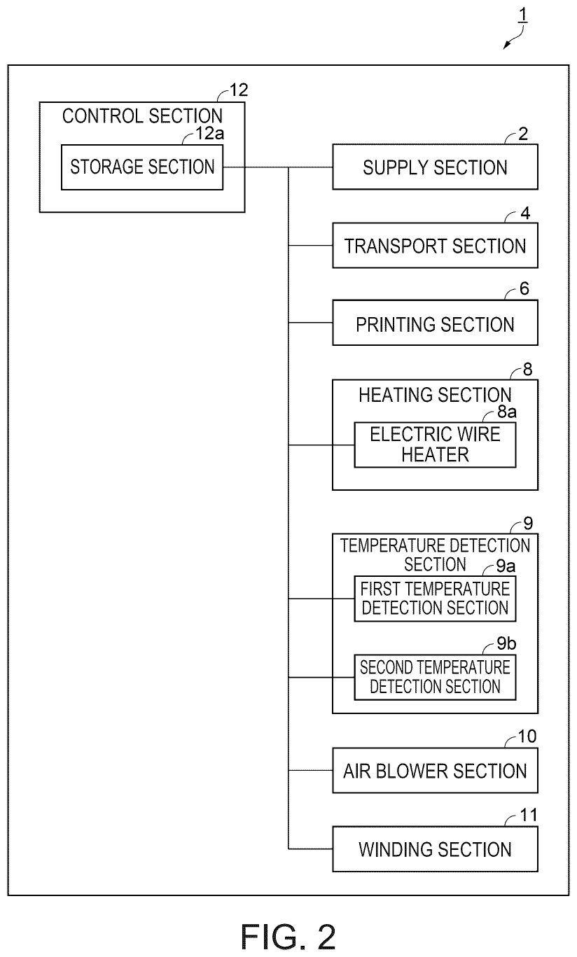

The configuration of the printing device 1 will be described with reference to FIGS. 1 to 3. As illustrated in FIGS. 1 and 2, the printing device 1 includes a supply section 2, a guide 3, a transport section 4, a platen 5, a printing section 6, a medium support section 7, a heating section 8, a temperature detection section 9, an air blower section 10, a winding section 11, and a control section 12. The medium M is transported along a surface of each of the guide 3, the platen 5, and the medium support section 7, which are surfaces that support the medium M. A direction along the surfaces of the guide 3, the platen 5, and the medium support section 7 is a transport direction F of the medium M. The transport direction F intersects the X axis. Note that the supply section 2, the guide 3, the transport section 4, the platen 5, the printing section 6, the medium support section 7, the heating section 8, the temperature detection section 9, the air blower section 10, and the winding section 11 are disposed from the upstream side to the downstream side in the transport direction F.

The medium M is, for example, paper such as plain paper, synthetic paper, or photographic paper, and has an elongated shape. The medium M is wound as a roll body R1 and set in the supply section 2 of the printing device 1. The supply section 2 can rotate the roll body R1 using a supply motor (not shown) and can supply the medium M from the roll body R1 in the transport direction F. Note that the medium M may be, for example, a single sheet of paper or a natural fiber fabric, a synthetic fiber fabric, or other fabric.

The guide 3 guides the medium M supplied from the supply section 2 toward the transport section 4. The transport section 4 includes a drive roller 4a and a driven roller 4b. The transport section 4 drives the drive roller 4a using a transport motor (not shown), and transports the medium M toward the platen 5 while sandwiching the medium M between the drive roller 4a and the driven roller 4b. Note that the driving and driven relationship of the drive roller 4a and the driven roller 4b may be reversed.

The medium M transported toward the platen 5 by the transport section 4 reaches a position between the platen 5 and the printing section 6, which face each other. The platen 5 supports the medium M. The printing section 6 includes an ink jet head (not shown) and a carriage (not shown). The printing section 6 performs printing on the medium M by applying ink. The carriage is movable in the left-right direction by a carriage motor (not shown).

The printing device 1 is, for example, configured to be mounted with ink cartridges or ink tanks storing inks in colors of CMYK (Cyan, Magenta, Yellow, Black), which are ink colors. The printing section 6 includes a supply mechanism (not shown) that supplies ink from an ink cartridge or the like to the head. The supply mechanism supplies the ink of each color from an ink cartridge or the like to nozzles (not shown) formed in the head.

The head is mounted on a carriage and reciprocates in the left-right direction above the medium M together with the carriage, which is movable in the left-right direction. The head applies ink downward from the nozzles while moving above the medium M under the control of the control section 12 based on the print data. As a result, ink is applied to a first surface M1, which is the printing surface of the medium M. Note that the ink colors may be any combination of four or more colors, for example, including CMYK light and dark colors. The ink contains a solvent. For example, when the ink is an eco solvent ink, the ink contains a pigment and an organic solvent.

The medium M to which ink is applied by the printing section 6 is transported to the medium support section 7, which is disposed on the downstream side of the platen 5 in the transport direction F. The medium support section 7 supports the medium M to which ink was applied. The medium support section 7 is formed with a bent section 7a at the upstream side. The medium support section 7 is shaped to bend at the bent section 7a from the forward direction to the forward-downward direction from upstream to downstream in the transport direction F.

The bent section 7a of the medium support section 7 changes the direction in which the medium M is transported from the forward direction to the forward-downward direction. That is, the medium M is transported downstream in the transport direction F through the bent section 7a and, by this, the first surface M1 of the medium M changes from being inclined upward to being inclined forward. Note that the medium M might be creased if the bent section 7a were formed in an angular shape. Therefore, the bent section 7a is preferably formed to have a circular arc shape in cross section as viewed from the left direction or the right direction.

The heating section 8 is disposed across a wide range of the rear surface of the medium support section 7, which is positioned on the opposite side than the front surface, and heats the medium M supported by the medium support section 7 through the medium support section 7. As the heating section 8, for example, a heat source lamp, a sheathed heater, a tube heater, a rubber heater, or the like can be applied. In the present embodiment, the heating section 8 is configured by a electric wire heater 8a, and a tube heater, which is a single elongated member, is applied.

The ink applied to the medium M is heated by the heating section 8 from a second surface M2, which is the transport surface of the medium M. At this time, the solvent contained in the ink converts into a gas and escapes from the medium M from the first surface M1. In the following description, vaporization of the solvent is referred to as evaporation and, particularly in the case of an organic solvent, as volatilization. For example, when the medium M is printed with eco solvent ink, the medium M is heated from the second surface M2 by the heating section 8, the organic solvent volatilizes from the first surface M1, and the pigments remain on the medium M.

As described below, a predetermined tension is applied to the medium M transported by the transport section 4 by being wound up by the winding section 11. The medium Mis bent at the bent section 7a of the medium support section 7 in a state in which a predetermined tensile force is applied, and, by this, the second surface M2 is prevented from rising up from the surface of the medium support section 7. The second surface M2 of the medium M is in contact with the surface of the medium support section 7, and thus heat is easily transferred to the medium M, and evaporation of solvents from the first surface M1 is promoted.

Note that in order to prevent the second surface M2 from rising up from the surface of the medium support section 7, the transport direction F of the medium M at the downstream end of the medium support section 7 is preferably changed to a more downward direction than the transport direction F that was changed by the bent section 7a to the forward-downward direction. The medium M could be creased if the downstream end of the medium support section 7 were formed to be angular, so it is preferable that the downstream end of the medium support section 7 be formed to have a circular arc shape in cross section as viewed from the left direction or the right direction.

The temperature detection section 9 is disposed at the rear surface of the medium support section 7 and detects the temperature of the medium support section 7. The temperature detection section 9 includes a first temperature detection section 9a and a second temperature detection section 9b. For example, temperature measurement resistors, linear resistors, thermistors, and the like can be applied as the first temperature detection section 9a and the second temperature detection section 9b. In the present embodiment, thermistors, which are temperature detection elements, are applied as the first temperature detection section 9a and the second temperature detection section 9b. The first temperature detection section 9a is disposed in the vicinity of the heating section 8 that, among the heating sections 8 disposed across a wide range on the rear surface of the medium support section 7, is disposed on the downstream side and can detect the temperature in the vicinity of the heating section 8 that is disposed on the downstream side. The second temperature detection section 9b is disposed in the vicinity of the heating section 8 that, among the heating sections 8 disposed across a wide range on the rear surface of the medium support section 7, is disposed on the upstream side and can detect the temperature in the vicinity of the heating section 8 that is disposed on the upstream side.

Note that the temperature detection section 9 was described as being disposed on the rear surface of the medium support section 7 and as detecting the temperature of the medium support section 7, but, for example, the temperature detection section 9 may be internalized in the vicinity of the front surface of the medium support section 7 to detect the surface temperature of the medium support section 7 or may detect the temperature of the medium M.

The air blower section 10 is disposed to face the medium support section 7 and blows air toward the medium support section 7. The air blower section 10 is disposed at a position facing the electric wire heater 8a that, amongst the heating section 8, is disposed on the upstream side in the transport direction F, with the medium support section 7 interposed therebetween. The air blower section 10 includes a fan 10a. The air blower section 10 can blow air toward the first surface M1 of the medium M supported and heated at the medium support section 7. The winding section 11 winds up the medium M that was dried by the heating section 8 and the air blower section 10 as a rolled up body R2. The winding section 11 includes a winding motor (not shown) and can rotate the rolled up body R2.

The control section 12 includes a central processing section (CPU) that integrally controls each section of the printing device 1, a universal asynchronous receiver transmitter (UART) that manages input and output, a field programmable gate array (FPGA), a programmable logic device (PLD) that is a logic circuit, and the like. The CPU is also referred to as a processor. The control section 12 includes a storage section 12a. The storage section 12a includes a flash read only memory (ROM) or a hard disk drive (HDD), which are rewritable nonvolatile memories, a random access memory (RAM), which is a volatile memory, and the like. The control section 12 reads a program such as firmware stored in nonvolatile memory of the storage section 12a and executes various programs using volatile memory of the storage section 12a as a work area.

As shown in FIG. 2, the supply section 2, the transport section 4, the printing section 6, the heating section 8, the temperature detection section 9, the air blower section 10, and the winding section 11 are controlled by the control section 12 executing various programs.

The control section 12 further includes an analog-to-digital (A/D) converter (not shown), and can calculate the temperature based on the resistance value of the temperature detection section 9, which changes in response to changes in temperature. The storage section 12a stores a temperature table with correspondence of resistance values of the temperature detection section 9. The control section 12 can refer to the storage section 12a and acquire the temperature that corresponds to the resistance value of the temperature detection section 9. In this way, the control section 12 can know the temperature of the medium support section 7 detected by the temperature detection section 9.

The control section 12 can determine the temperature of the medium support section 7 that was detected by the temperature detection section 9 and adjust the temperature of the heating section 8. Note that the control section 12 can, for example, control the temperature of the heating section 8 by controlling the power supplied to the heating section 8 by a transistor or the like. In the following description, the control section 12 adjusting the temperature of the heating section 8 is referred to as temperature control. The control section 12 performs so-called temperature feedback control in which power applied to the heating section 8 is controlled so that the temperature of the medium support section 7 detected by the temperature detection section 9 becomes a predetermined value.

The control section 12 can perform temperature control on the heating section 8 based on the temperature detected by the first temperature detection section 9a. The control section 12 can also perform temperature control of the heating section 8 based on the temperature detected by the second temperature detection section 9b. In this way, the control section 12 can perform temperature control of the heating section 8 individually based on the temperature detected by the first temperature detection section 9a and the temperature detected by the second temperature detection section 9b.

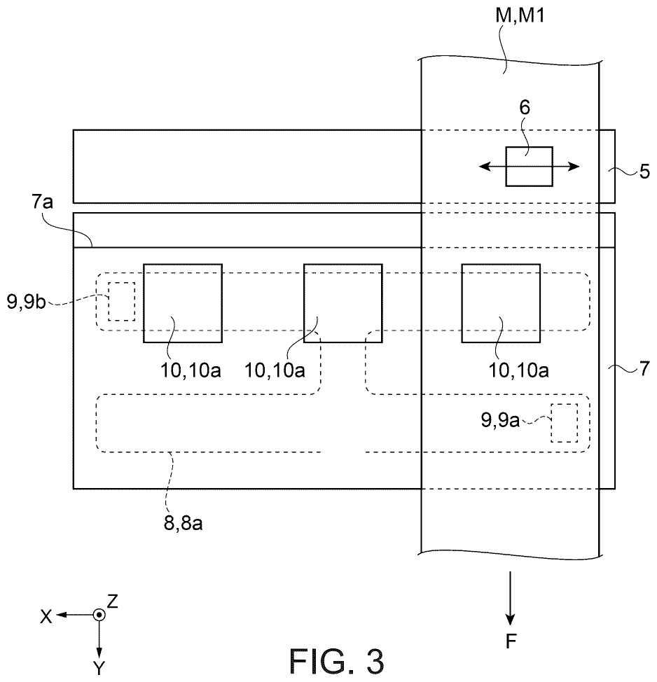

As shown in FIG. 3, the medium M is transported from upstream to downstream in the transport direction F, in between the platen 5 and the printing section 6, which face each other. The printing section 6 prints by applying ink to the first surface M1, which is the printing surface of the medium M, while moving back and forth in the left-right direction above the medium M. The medium M printed on by the printing section 6 is further transported from the upstream side to the downstream side in the transport direction F, in between the medium support section 7 and the air blower section 10, which are positioned on the downstream side of the platen 5 and face each other.

The first temperature detection section 9a of the temperature detection section 9 is disposed on the right side, which is the −X direction, at the rear surface of the medium support section 7. It is disposed in the vicinity of the electric wire heater 8a that, of the heating section 8, which is disposed at the back surface of the medium support section 7, is disposed on the downstream side. The second temperature detection section 9b is disposed on the left side, which is the +X direction, at the rear surface of the medium support section 7. The second temperature detection section 9b is disposed in the vicinity the electric wire heater 8a that, of the heating section 8, which is disposed at the back surface of the medium support section 7, is disposed on the upstream side.

In the printing device 1 according to the embodiment, it is possible to apply the ink to the medium M even if mediums M that have different sized widths in the width direction, such as 10 inches or 64 inches, are transported. The medium M is supported with the right end of the medium M in the width direction along the right side of the medium support section 7. Note that in a region of the surface of the medium support section 7 at a position at which the medium M is supported, heat of the medium support section 7 heated by the heating section 8 is taken away by the medium M. In the following description, a region of the medium support section 7 at a position where the medium M is supported is referred to as a “support region”. In the present embodiment, the first temperature detection section 9a is disposed at the right side of the medium support section 7, and therefore can detect the temperature of the support region even when different sized mediums M are transported.

In a region of the surface of the medium support section 7 located where the medium M is not supported, the heat of the medium support section 7 heated by the heating section 8 is not taken by the medium M. In the following description, a region of the medium support section 7 at a position where the medium M is not supported is referred to as a “non-support region”. In the present embodiment, the second temperature detection section 9b is disposed on the left side of the medium support section 7, and thus can detect the temperature of the non-support region even when mediums M of different sizes are transported. Note that there is no non-support region when a medium M is transported that, as the size of the medium M in the width direction, has a size that covers the entire medium support section 7 in the width direction. In this case, the second temperature detection section 9b detects the temperature of the medium support section 7 that had heat removed by the medium M.

The air blower section 10 is disposed at a position facing the electric wire heater 8a that, of the heating section 8, is disposed on the upstream side in the transport direction F with the medium support section 7 interposed therebetween. The medium M transported to the medium support section 7 faces the blower section 10. The air blower section 10 includes a plurality of fans 10a arranged in the widthwise direction of the medium support section 7. In the present embodiment, three fans 10a of the air blower section 10 are arranged side by side in the left-right direction, which is the widthwise direction of the medium M.

Note that the number of fans 10a of the air blower section 10 may be any number. The control section 12 can individually control the fans 10a. For example, only the fan 10a at an arbitrary position may be operated, or the air volume of a fan 10a selected in accordance with the size of the transported medium M in the widthwise direction may be changed. In this manner, the medium M transported to the medium support section 7 is dried by being heated through the medium support section 7. Furthermore, the drying of the medium M is promoted by air blown from the air blower section 10 hitting the medium M.

As described above, in the support region of the medium support section 7, the heat of the medium support section 7 is taken away by the medium M. Therefore, the control section 12 performs feedback control on the heating section 8 so that a first detected temperature detected by the first temperature detection section 9a of the temperature detection section 9 becomes a predetermined set temperature. As the feedback control, for example, a proportional integral differential controller (PID controller) can be applied. Note that when the printing time continues to some extent, the heating by the heating section 8 and the heat taken away by the medium M may approach an equilibrium state. In this case, the first detected temperature is stable, with little fluctuation, at a temperature lower than the set temperature.

The temperature at the non-support region of the medium support section 7 will be higher than that at the support region because heat of the medium support section 7 is not removed by the medium M. Therefore, the control section 12 performs temperature control so that the temperature of the non-support region does not become excessively high. To be specific, the control section 12 suppresses the output of the heating section 8 when a second detected temperature detected by the second temperature detection section 9b rises and reaches an upper limit set temperature. The output of the heating section 8 is limited to, for example, 10%. By this restriction, the medium support section 7 is temperature controlled so as not to exceed the upper limit set temperature, and the safety of the printing device 1 is secured. The upper limit set temperature is, for example, 62° C.

In a case where the air blower section 10 is not operating due to a failure or the like, the temperature of the non-support region of the medium support section 7 increases to an even greater extent than that of the support region since the heat of the medium support section 7 is not removed by the air blower section 10. Therefore, the control section 12 determines whether or not the air blower section 10 is operating and suppresses the output of the heating section 8 upon determining that the air blower section 10 is not operating. The output of the heating section 8 is limited to, for example, 50%. By this restriction, the temperature of the non-support region of the medium support section 7 is temperature controlled so as not to exceed a specific temperature, and the safety of the printing device 1 is secured. The specific temperature is 60° C., for example. Note that the method of determining that the air blower section 10 is not operating can be performed by the control section 12 executing an operation confirmation program for the air blower section 10 in advance.

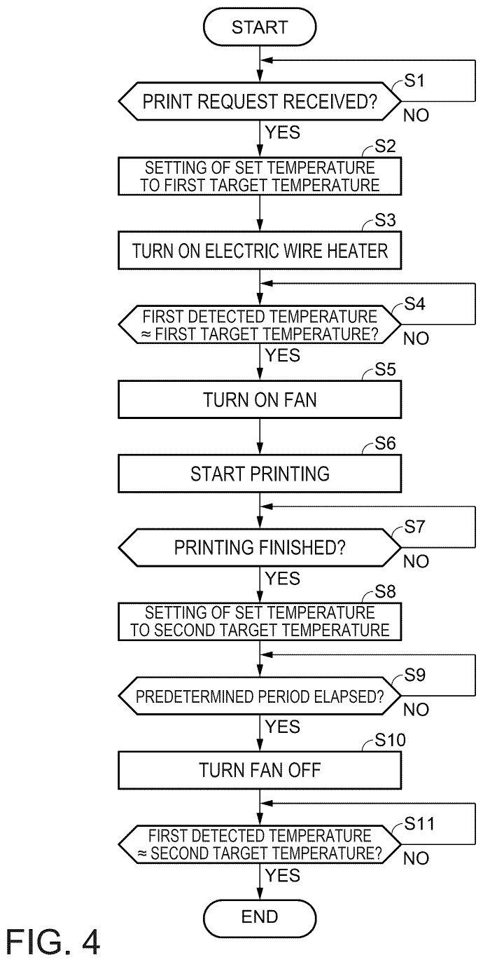

Hereinafter, the temperature control of the printing device 1 will be described with reference to FIG. 4. Note that the subsequent operations are controlled by the control section 12. In the following description, “printing operation” includes the operation of applying ink to the medium M under the control of the control section 12 and based on the printing data and transporting the medium M so that the portion thereof to which the ink was applied is positioned facing the air blower section 10. The term “during printing” refers to a period from the start to the end of the “printing operation”. “At the time when printing finished” indicates a point in time “during printing” when the “printing operation” ends. “Printing is finished” or “printing finished” indicates that the “printing operation” is finished. “After printing is finished” indicates a period after the “printing operation” is completed.

As shown in FIG. 4, first, in step S1, the control section 12 determines whether or not a print request was received from an external computer (not shown) or the like. If the determination in step S1 is “NO”, step S1 is repeated until a print request is received. When the determination in step S1 is “YES”, the process proceeds to step S2.

In step S2, the control section 12 sets the set temperature used for the temperature control to a first target temperature that was stored in the storage section 12a in advance. The first target temperature is a temperature at which the printed medium M can be dried, and is an example of a temperature that the control section 12 attempts to achieve using PID control during printing. The first target temperature is determined in advance by experiment and stored in the storage section 12a. The first target temperature is 50° C., for example. Note that the first target temperature may be set by the user in a range of 35° C. to 55° C., for example, according to conditions such as the environmental temperature, the composition of the ink, and the amount of ink applied.

When the organic solvent included in eco solvent ink is to be volatilized from the medium M, it is preferable that the control section 12 performs temperature control by setting the temperature of the medium support section 7 heated by the heating section 8 in a range of 35° C. to 55° C.

Next, in step S3, the control section 12 turns on the electric wire heater 8a and starts heating the medium support section 7. Next, in step S4, the control section 12 determines whether or not the first detected temperature detected by the first temperature detection section 9a has reached the first target temperature set in step S2. If the determination result in step S4 is “NO”, step S4 is repeated until the first detected temperature reaches the first target temperature. When the determination result is “YES” in step S4, the process proceeds to step S5.

In step S5, the control section 12 turns on the operation of the fan 10a to start blowing air toward the medium support section 7 in preparation for the start of printing in the next step S6. Note that the control section 12 continues blowing air from the fan 10a during printing to accelerate drying of the medium M that is wet due to ink application, and to cool the non-support region so that the temperature of the non-support region does not rise to a predetermined temperature or higher. Next, in step S6, the control section 12 starts printing on the medium M.

Next, in step S7, the control section 12 determines whether or not printing has finished. If the determination result in step S7 is “NO”, step S7 is repeated until printing is finished. When the determination result is “YES” in step S7, the process proceeds to step S8.

In step S8, the control section 12 sets the set temperature used for the temperature control after printing is finished to a second target temperature. The second target temperature is lower than the first target temperature, which was the set temperature for during printing. In other words, in step S8, the control section 12 sets the set temperature after printing is finished to be lower than the set temperature for during printing. The second target temperature is the temperature at which printing is allowed to be started without waiting for the temperature of the heating section 8 to rise even when the next print request is received, and is an example of a temperature that, after printing is finished, the control section 12 attempts to achieve using PID control.

The control section 12 may set the second target temperature, which is the set temperature after printing is finished, to the same temperature as the first detected temperature when, based on the first detected temperature during printing, the fluctuation is small and stable during printing. Alternatively, based on the first detected temperature at the time when printing finished, the control section 12 may set the second target temperature, which is the set temperature after printing is finished, to the same temperature as the first detected temperature detected at the time when printing finished. The first detected temperature during printing and at the time when printing is finished is detected as a temperature lower than the first target temperature, which is the set temperature during printing. This is because heat of the medium support section 7 is lost as the solvent evaporates from the first surface M1 on the medium support section 7 heated by the heating section 8. Alternatively, this is because the temperature of the medium support section 7 is insufficient due to the influence of the output of the heating section 8. By this, the set temperature after printing is finished can be set lower than the set temperature during printing.

Next, in step S9, the control section 12 determines whether or not a predetermined period has elapsed since printing finished. In other words, it is determined whether or not a predetermined period has elapsed since a “YES” determination in step S7. If the determination result in step S9 is “NO”, then step S9 is repeated until the predetermined period of time elapses after printing is completed. When the determination result is “YES” in step S9, then the process proceeds to step S10.

In step S10, the control section 12 turns off the operation of the fan 10a to stop blowing air toward the medium support section 7. In this way, the control section 12 operates the fan 10a to continue blowing air from the blower section 10, not only during printing but also during the period from after printing is finished in step S7, during the predetermined period of step S9, and until step S10. The predetermined period is determined in advance by experiment and is stored in the storage section 12a. The predetermined period is, for example, 30 seconds.

As described above, in the present embodiment, the set temperature after printing is finished is set to be lower than the set temperature during printing. In the embodiment, since the heating section 8 is subjected to PID control, the output of the heating section 8 may be temporarily increased after printing is finished in order to compensate for the decrease in temperature after printing is finished. Accordingly, the temperature of the non-support region of the medium support section 7 may rise, but since air blowing is continued for a predetermined period after printing is finished, it is possible to suppress an excessive rise in the temperature of the non-support region.

Next, in step S11, the control section 12 determines whether or not the first detected temperature detected by the first temperature detection section 9a is substantially equal to the second target temperature. If the determination result in step S11 is “NO”, then step S11 is repeated until the first detected temperature becomes substantially equal to the second target temperature. When the determination result in step S11 is “YES”, the control section 12 continues the second target temperature and waits for a new print request. Note that when a new print request is received, the control section 12 proceeds to step S1 and starts printing on the medium M.

In this way, the medium M is heated through the medium support section 7 by the temperature control of the control section 12, and the solvents evaporate from the first surface M1. The solvents evaporated from the first surface M1 are blown off by the air blown from the air blower section 10. Accordingly, drying of the medium M is promoted.

As described above, according to the printing device 1 of the present embodiment, the following effects can be obtained. According to the printing device 1, the control section 12 sets the second target temperature, which is the set temperature after printing is finished, to be lower than the first target temperature, which is the set temperature during printing, to maintain the temperature of the medium support section 7 after printing is finished, and thus it is possible to prevent the temperature of the medium support section 7 from being excessively lowered. Thus, printing can be smoothly resumed.

According to the printing device 1, since the control section 12 sets the second target temperature, which is the set temperature after printing is finished, based on the first detected temperature during printing, it is possible to set the set temperature after printing is finished to the detected temperature in which the actual situation during printing is reflected. This also enables smooth resumption of printing.

According to the printing device 1, since the control section 12 sets the second target temperature, which is the set temperature after printing is finished, based on the first detected temperature at the time when printing finished, the set temperature after printing is finished can be set to the detected temperature in which the actual situation at the time when printing finished is reflected. This also enables smooth resumption of printing.

According to the printing device 1, the temperature detection section 9 detects the temperature of the medium support section 7 at a position where the medium M is supported. Accordingly, it is possible to more accurately detect the first detected temperature necessary for smoothly resuming printing, compared to a case where the temperature of the medium support section 7 is detected at a position where the medium M is not supported.

According to the printing device 1, since the control section 12 performs PID control on the heating section 8, it is possible to perform feedback control with a quick response, stable control, and suppression of rapid change.

According to the printing device 1, the air blower section 10 that is disposed to face the medium support section 7 and that blows air toward the medium support section 7 is provided, and the control section 12 continues blowing air from the air blower section 10 for a predetermined period after printing is finished. Accordingly, it is possible to promote drying of the medium M and to suppress an excessive increase in the temperature of the non-support region.

According to the printing device 1, the heating section 8 heats the medium M through the medium support section 7, and thus it is possible to uniformly heat the medium M.

Although the present embodiment has been described in detail with reference to the drawings, the specific configuration is not limited to the present embodiment, and changes, substitutions, deletions, and the like may be made without departing from the gist of the present disclosure. Other embodiments described below may be employed. Even in these cases, the same effects as that of the present embodiment can be obtained.

In the embodiment, the printing section 6 of the printing device 1 is described as a so-called serial type in which the head is mounted on the carriage and moves, but for example, the printing section 6 may be a so-called line type, which has no carriage and in which the head is fixed.

In the present embodiment, the control section 12 is described as performing temperature control of a tube heater that is a single elongated member, but the control section 12 may perform temperature control on tube heaters of two or more elongated members.

In the present embodiment, PID control is described using a predetermined temperatures as examples of the set temperature, the detected temperature, and the like, but PID control may perform PID gain tuning so that the difference between the set temperature and the current detected temperature has a predetermined width.

In the embodiment, the “printing operation” includes an operation under the control of the control section 12 based on printing data, of applying ink to the medium M, and transporting the section of the medium M to which the ink was applied to a position facing the air blower section 10. However, this is not a limitation. The “printing operation” may be an operation of applying ink to the medium M under the control of the control section 12 based on the printing data. After the first detected temperature reaches the first target temperature in step S4, the medium support section 7 is cooled by air blown from the fan 10a that is turned on in step S5. Therefore, even if the medium M is not transported to the position facing the air blower section 10, the first detected temperature is detected lower than the first target temperature. In this case also, the set temperature after printing is finished can be set based on the first detected temperature at the time when printing finished, which is lower than the first target temperature, which is the set temperature during printing.

In the present embodiment, the control section 12 sets the set temperature after printing is finished to the same temperature as the first detected temperature, based on the first detected temperature at the time when printing finished, but this is not a limitation. For example, the control section 12 may set the set temperature after printing is finished to a temperature different from the first detected temperature at the time when printing finished. Specifically, the control section 12 may set the set temperature after printing is finished to be lower, by a predetermined temperature, than the first detected temperature at the time when printing finished. The predetermined temperature is determined in advance by experiment and is stored in the storage section 12a. The predetermined temperature is 3° C., for example. According to the printing device 1, since the control section 12 sets the set temperature after printing is finished to be lower, by the predetermined temperature, than the first detected temperature at the time when printing finished, it is possible to further suppress the power consumption of the printing device 1 in addition to the same effects as those of the embodiment.

Further, in the present embodiment, the control section 12 operates the fan 10a to continue the air blowing from the air blower section 10 for a predetermined period after printing is finished, but this is not a limitation. For example, after printing is finished in step S7, the control section 12 may reduce the air blowing amount of the fan 10a that, among the plurality of fans 10a, faces the medium M supported in the support region. According to the printing device 1, since the air blowing amount by the fan 10a facing the medium M is reduced, it is possible to suppress the power consumption of the printing device 1 in addition to the same effects as those of the present embodiment.

What is claimed is:

1. A printing device comprising:
a printing section that performs printing on a medium by applying a liquid;
a medium support section that supports the medium to which the liquid is applied;
a heating section that heats the medium supported by the medium support section;
a temperature detection section that detects a temperature of the medium or of the medium support section; and
a control section configured to perform feedback control on the heating section such that a detected temperature detected by the temperature detection section becomes a set temperature, wherein
the control section sets the set temperature after printing is finished to be lower than the set temperature during printing.

2. The printing device according to claim 1, wherein
the control section sets the set temperature after printing is finished based on a detected temperature during printing.

3. The printing device according to claim 2, wherein
the control section sets the set temperature after printing is finished based on the detected temperature at the time when printing finished.

4. The printing device according to claim 3, wherein
the control section sets the set temperature after printing is finished to be lower, by a predetermined temperature, than the detected temperature at the time when printing finished.

5. The printing device according to claim 1, wherein
the temperature detection section detects a temperature of the medium support section at a position where the medium is supported.

6. The printing device according to claim 1, wherein
the control section performs PID control on the heating section.

7. The printing device according to claim 1, further comprising:
a blower section that is disposed to face the medium support section and that blows air toward the medium support section, wherein
the control section continues blowing air from the blower section for a predetermined period after printing is finished.

8. The printing device according to claim 7, wherein
the air blower section includes a plurality of fans disposed in a width direction of the medium support section and, after printing is finished, the control section reduces an air blowing amount of a fan that faces the medium.

9. The printing device according to claim 1, wherein
the heating section heats the medium through the medium support section.

10. The printing device as claimed in claim 9, wherein
the heating section is an electric wire heater.
